(19) United States
(12) Patent Application Publication
(10) Pub. No.: US 2017/0195613 A1
(43) Pub. Date: Jul. 6, 2017

(54) METHOD AND ELECTRONIC DEVICE FOR DISPLAYING VIDEO BEING PLAYED

(71) Applicants: Le Holdings (Beijing) Co., Ltd., Beijing (CN); LE SHI INTERNET INFORMATION & TECHNOLOGY CORP., BEIJING, Beijing (CN)

(72) Inventor: Wei YANG, Beijing (CN)

(21) Appl. No.: 15/245,635

(22) Filed: Aug. 24, 2016

Related U.S. Application Data
(63) Continuation of application No. PCT/CN2016/089225, filed on Jul. 7, 2016.

(30) Foreign Application Priority Data
Dec. 31, 2015 (CN) 201511032348.X

(51) Int. Cl. H04N 5/445; H04N 5/268

(52) U.S. Cl. CPC H04N 5/44591; H04N 5/268

(57) ABSTRACT

A method for displaying a video being played is disclosed. The method includes: at an electronic device, receiving an interface switch instruction under a play interface of a target video; executing an interface switch operation according to the interface switch instruction; displaying the switched interface and displaying a small floating window in the switched interface; and continuing to play the target video in the small floating window.

### CROSS REFERENCE TO RELATED APPLICATIONS

The present disclosure is a continuation application of PCT International patent application No. PCT/CN2016/089225, filed on Jul. 7, 2016, which claims priority to Chinese Patent Application No. 201511032348.X, filed with the Chinese Patent Office on Dec. 31, 2015, both of which are herein incorporated by reference in their entireties.

### TECHNICAL FIELD

The present disclosure relates to the field of video play technologies, and in particularly, to a method and an electronic device for displaying a video being played.

### BACKGROUND

Generally, when a certain application in existing smart terminals (e.g., smartphones, tablet PCs) is being used, if another application has a push message, it is common that a message prompt bar appears on the top of the current interface to prompt a user, and by clicking the message prompt bar, the user is allowed to enter the corresponding application to view content. The screen generally jumps to the interface of another application, and the video which is being currently watched has to be closed. If the user wants to continue to watch the original video, the user has to exit from the new application back to the original video application, which is a rather complicated process and creates poor user experiences.

Moreover, while using the existing video software, if the user wants to browse a video list to select a more interested one when watching a video, the user needs to exit from the currently playing video to make a selection, which inevitably results in that other videos can be browsed only when the current video is closed.

### SUMMARY

A method for displaying a video being played is provided in an embodiment of the present disclosure. The method includes: at an electronic device, receiving an interface switch instruction under a play interface of a target video; executing an interface switch operation according to the interface switch instruction; displaying the switched interface and displaying a small floating window in the switched interface; and continuing to play the target video in the small floating window.

An electronic device is provided in another embodiment of the present disclosure. The electronic device includes at least one processor and a memory communicably connected with the at least one processor for storing instructions executable by the at least one processor, wherein execution of the instructions by the at least one processor causes the at least one processor to:

receive an interface switch instruction under a play interface of a target video;

execute an interface switch operation according to the interface switch instruction;

display the switched interface and displaying a small floating window in the switched interface; and

continue to play the target video in the small floating window.

A non-transitory computer-readable storage medium is provided in still another embodiment of the present disclosure. The non-transitory computer-readable storage medium stores executable instructions, wherein when executed by an electronic device, causes the electronic device to:

receive an interface switch instruction under a play interface of a target video;

execute an interface switch operation according to the interface switch instruction;

display the switched interface and display a small floating window in the switched interface; and

continue to play the target video in the small floating window.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a schematic flowchart of an embodiment of a method for displaying a video being played according to the present disclosure;

FIG. 2 is a schematic flowchart of another embodiment of a method for displaying a video being played according to the present disclosure;

FIG. 3 is a schematic module structure diagram of an embodiment of an apparatus for displaying a video being played according to the present disclosure; and

FIG. 4 is a hardware structure diagram of an embodiment of a smart terminal according to the present disclosure.

### DETAILED DESCRIPTION

To make the objectives, technical solutions and advantages of the present disclosure more comprehensible, the present disclosure is further described in detail below in combination with embodiments and with reference to the accompanying drawings.

It should be noted that all expressions using “first” and “second” in embodiments of the present disclosure are intended to distinguish two different entities or different parameters with the same name; thus, “first” and “second” are merely for ease of expression, but should not be understood as limitations to the embodiments of the present disclosure, which is not described one by one in the following embodiments.

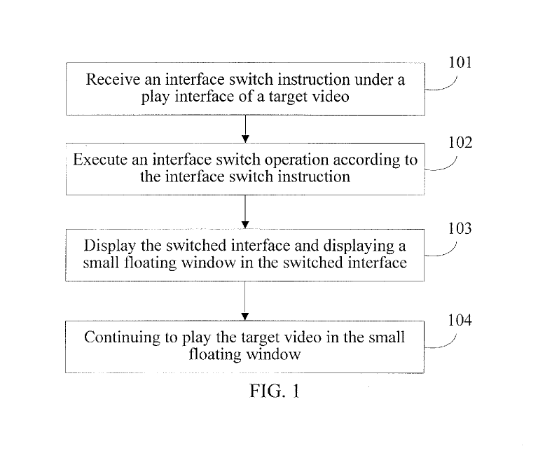

In a first aspect of the present disclosure, a method for displaying a video being played is provided, which enables a user to continue to watch the video after the interface jumps to another and will not lead to video interruption. As shown in FIG. 1, it is a schematic flowchart of an embodiment of a method for displaying a video being played according to the present disclosure.

The method for displaying a video being played includes:

In step 101: receiving an interface switch instruction under a play interface of a target video; that is, it is currently in an interface of playing the target video, and an instruction is received to switch from the current play interface to another interface;

In step 102: executing an interface switch operation according to the interface switch instruction; that is, corresponding interface switches are conducted according to the corresponding interface switch instructions, for example, invoking and starting other applications, and so on;

In step 103: displaying the switched interface and displaying a small floating window in the switched interface; the small floating window merely occupies a part of the interface; and

In step 104: continuing to play the target video in the small floating window.

It can be seen from the above embodiments that, according to the method for displaying a video being played provided in the present disclosure, it is feasible to, when a video play interface is switched to another interface, form a small floating window in the new interface and continue to play the video in the small floating window, so that the user can do what he/she wants to do in the new interface without interrupting the user from continuing to watching the video. The method provided in the present disclosure enriches the operations and enhances user experiences.

In some exemplary embodiments, the interface switch instruction includes an inter-application switch instruction, an in-application switch instruction and a main interface return instruction. That is, the method for displaying a video being played can adapt to interface switch in various scenarios, and the use thereof is more flexible.

In some exemplary embodiments, the method for displaying a video being played further includes the following steps:

receiving a small floating window control instruction;

determining the type of the small floating window control instruction;

if the small floating window control instruction is a zoom control instruction, zooming the small floating window;

if the small floating window control instruction is a drag control instruction, moving the small floating window;

if the small floating window control instruction is a close control instruction, closing the small floating Window; and

if the small floating window control instruction is a restore control instruction, returning to the play interface of the target video and continuing to play the target video.

The above various types of control instructions all can be achieved by clicking buttons set around the small floating window, or achieved by clicking the small floating window and performing a corresponding gesture operation, for example, the zoom control instruction achieves zooming by pressing a zoom button on a corner of the small floating window and then dragging the small floating window, the drag control instruction achieves dragging and displacement by pressing and dragging the small floating window, the close control instruction is achieved by clicking a close button on a corner of the small floating window, and the restore control instruction may be achieved by clicking a restore button on a corner of the small floating window or by double-clicking the small floating window.

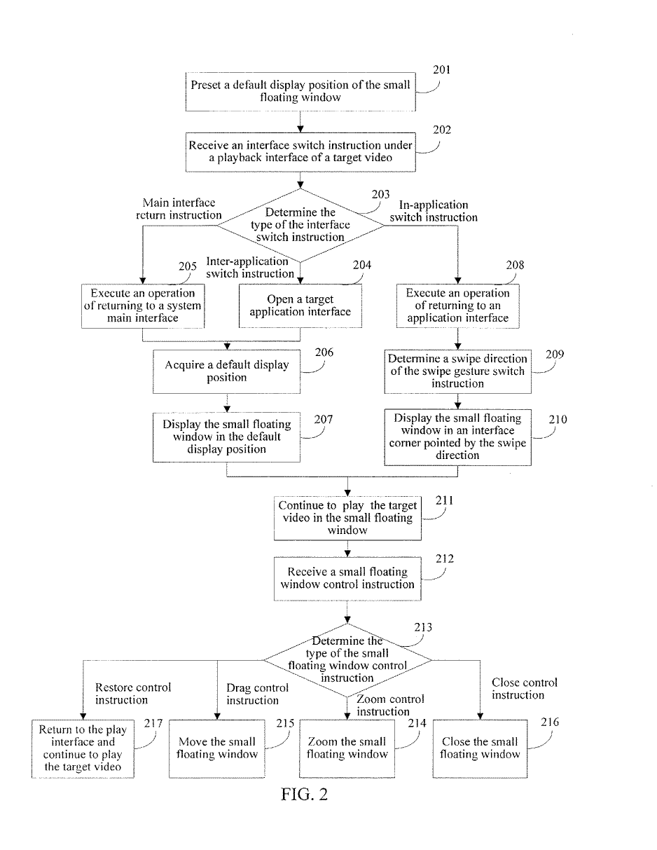

As shown in FIG. 2, it is a schematic flowchart of another embodiment of a method for displaying a video being played according to the present disclosure.

The method for displaying a video being played includes:

In step 201: presetting a default display position of the small floating window in different applications, wherein

if the interface switch instruction is an inter-application switch instruction, the default display position of the small floating window is set to an area outside a key content display area of a switched application; and

if the interface switch instruction is the main interface return instruction, the default display position of the small floating window is set to a blank area on the main interface or a preset small floating window display position.

In some exemplary embodiments, the inter-application switch instruction is a corresponding application which can be automatically jumped to by clicking a push message. The main interface return instruction is sent by clicking a home key or the like of an apparatus.

The key content display area varies according to different applications, for example, if a switched application is WeChat, WeChat message content may often appear in an upper part of an interface, and thus the position is the key content display area. When the user needs to reply to the information, the keyboard area displayed below the interface needs to be used, and thus may also be regarded as the key content display area. In this case, the preferred display position of the small floating window is the middle portion of the interface. Likewise, if the switched application is a short message, it is similar to WeChat and is not repeated herein. Using this principle, it is also feasible to correspondingly set the position of the small floating window of other applications.

Default positions of the small floating window about different applications are preset, so that, after interface jump, the small floating window can be in the best position, to avoid blocking more important content and affecting the user's operations.

The main interface return instruction is closing the current play interface to display a system main interface of the apparatus, so that the user can find an application that he/she needs to use in the main interface to perform other operations. If the interface switch instruction is the main interface return instruction, the default display position of the small floating window is a blank area on the main interface (when the main interface is not full of application icons, the small floating window is placed in a position where no application icon is placed) or a preset display position of the small floating window on the main interface (when the main interface is full of application icons, the small floating window is displayed in a preset default position).

In step 202: receiving an interface switch instruction under a play interface of a target video;

In step 203: determining the type of the interface switch instruction;

In step 204: if the interface switch instruction is the inter-application switch instruction, opening a target application interface;

In step 205: if the interface switch instruction is the main interface return instruction, executing an operation of returning to a system main interface;

In step 206: acquiring a default display position of the small floating window corresponding to the switched application or the main interface;

In step 207: displaying the small floating window in the default display position;

In step 208: if the interface switch instruction is the in-application switch instruction, executing an operation of returning to an application interface before playing the target video;

The in-application switch instruction is used for zooming out the current play interface to display an interface prior to the play, so that the user can browse other contents that he/she is interested in therein. The in-application switch instruction includes a click switch instruction (optionally, the click switch instruction refers to an operation of clicking a zoom-out interface button set on the play interface or the like) and a swipe gesture switch instruction (i.e., performing switch control through a gesture);

In step 209: determining a swipe direction of the swipe gesture switch instruction;

In step 210: displaying the small floating window in an interface corner pointed by the swipe direction according to the swipe direction;

In some exemplary embodiments, the swipe direction is upper left, lower left, upper right and lower right directions respectively, so as to be distinguished from other operational gestures.

The play interface is operated by using a swipe gesture, thus simplifying the user's operations, being distinguished from the inter-application switch instruction, improving the user's operation efficiency, and enhancing user experience.

In step 211: continuing to play the target video in the small floating window;

In step 212: receiving a small floating window control instruction;

In step 213: determining the type of the small floating window control instruction;

In step 214: if the small floating window control instruction is a zoom control instruction, zooming the small floating window;

In step 215: if the small floating window control instruction is a drag control instruction, moving the small floating window;

In step 216: if the small floating window control instruction is a close control instruction, closing the small floating window; and

In step 217: if the small floating window control instruction is a restore control instruction, returning to the play interface of the target video and continuing to play the target video.

The above various types of control instructions all can be achieved by clicking buttons set around the small floating window, or achieved by clicking the small floating window and performing a corresponding gesture operation, for example, the zoom control instruction achieves zooming by pressing a zoom button on a corner of the small floating window and then dragging the small floating window, the drag control instruction achieves dragging and displacement by pressing and dragging the small floating window, the close control instruction is achieved by clicking a close button on a corner of the small floating window, and the restore control instruction may be achieved by clicking a restore button on a corner of the small floating window or by double-clicking the small floating window.

It can be seen from the above embodiments that, according to the method for displaying a video being played provided in the present disclosure, it is feasible to, when a video play interface is switched to an interface, form a small floating window in the new interface and continuing to play a video in the small floating window, so that the user can do what he/she wants to do in the new interface without delaying the user to continuously watch the video, thus achieving the aim of getting a double advantage, enriching operating functions, and enhancing user experience.

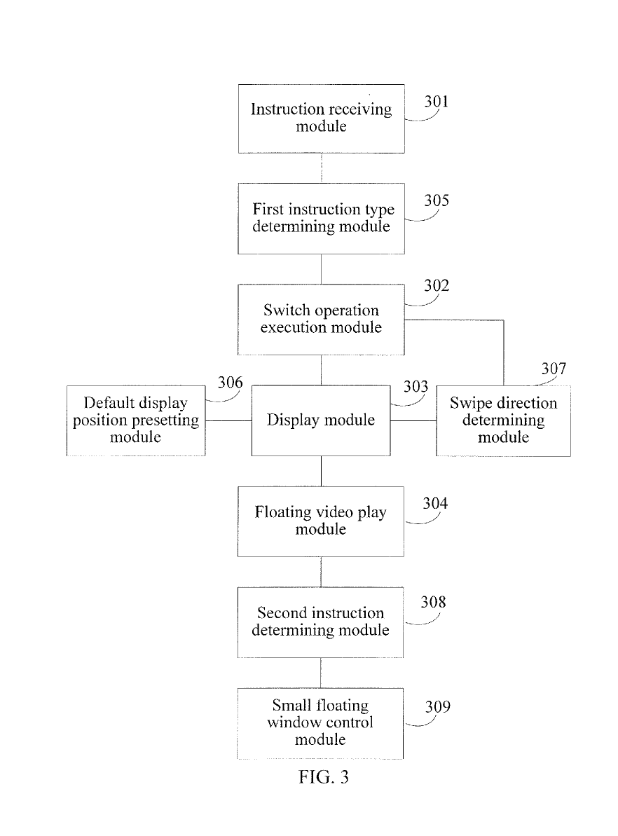

In a second aspect of the present disclosure, an apparatus for displaying a video being played is provided, which enables a user to continue to watch the video after the interface jumps to another and will not lead to video interruption. As shown in FIG. 3, it is a schematic module structure diagram of an embodiment of an apparatus for displaying a video being played according to the present disclosure.

The apparatus for displaying a video being played includes: an instruction receiving module 301, a switch operation execution module 302, a display module 303, and a floating video play module 304.

The instruction receiving module 301 is configured to receive an interface switch instruction under a play interface of a target video; that is, it is currently in an interface of playing a target video, and an instruction of switching from the current play interface to another interface is received;

The switch operation execution module 302 is configured to execute an interface switch operation according to the interface switch instruction; that is, corresponding interface switch processing is executed according to the corresponding interface switch instruction, for example, another application is invoked and started, and so on;

The display module 303 is configured to display the switched interface and displaying a small floating window in the switched interface; the small floating window merely occupies a part of the interface; and

The floating video play module 304 is configured to continue to play the target video in the small floating window.

It can be seen from the above embodiments that, according to the apparatus for displaying a video being played provided in the present disclosure, it is feasible to, when a video play interface is switched to another interface, form a small floating window in the new interface and continue to play the video in the small floating window, so that the user can do what he/she wants to do in the new interface without interrupting the user from continuing to watch the video, thus enriching operating functions, and enhancing user experience.

In some exemplary embodiments, the interface switch instruction includes an inter-application switch instruction, an in-application switch instruction and a main interface return instruction. That is, the method according to the present disclosure can adapt to interface switch in various scenarios, and the use thereof is more flexible.

In some exemplary embodiments, the apparatus further includes: a first instruction type determining module 305, configured to determine the type of the interface switch instruction.

If the interface switch instruction is an inter-application switch instruction, the switch operation execution module 302 opens a target application interface.

If the interface switch instruction is an in-application switch instruction, the switch operation execution module 302 executes an operation of returning to an application interface before playing the target video.

If the interface switch instruction is a main interface return instruction, the switch operation execution module 302 executes an operation of returning to a system main interface.

Through the above three manners, all scenarios of interface switch are basically covered, which has an extensive application range.

In some exemplary embodiments, the apparatus further includes a default display position presetting module 306, for presetting default display positions of the small floating window in different applications and in the main interface.

In some exemplary embodiments, if the interface switch instruction is an inter-application switch instruction, the default display position of the small floating window is set to an area outside a key content display area of a switched application.

If the interface switch instruction is a main interface return instruction, the default display position of the small floating window is set to a blank area on the main interface or a preset small floating window display position.

In some exemplary embodiments, the inter-application switch instruction is a corresponding application which can be automatically jumped to by clicking a push message. The main interface return instruction is sent by clicking a home key or the like of an apparatus.

The key content display area varies according to different applications, for example, if a switched application is WeChat, WeChat message content may often appear in an upper part of an interface, and thus the position is the key content display area. When the user needs to reply to the information, the keyboard area displayed below the interface needs to be used, and thus may also be regarded as the key content display area. In this case, the preferred display position of the small floating window is the middle portion of the interface. Likewise, if the switched application is a short message, it is similar to WeChat and is not repeated herein. Using this principle, it is also feasible to correspondingly set the position of the small floating window of other applications.

In some exemplary embodiments, if the interface switch instruction is an inter-application switch instruction, the display module 303 acquires a default display position of the small floating window corresponding to the switched application and displays the small floating window in the default display position.

Default positions of the small floating window about different applications are preset, so that, after the interface jumps to another, the small floating window can be in the best position, to avoid blocking more important content and affecting the user's operations.

The main interface return instruction is used for closing the current play interface to display a system main interface of the apparatus, so that the user can find an application that he/she needs to use in the main interface to perform other operations. If the interface switch instruction is a main interface return instruction, the default display position of the small floating window is set to a blank area on the main interface (when the main interface is not full of application icons, the small floating window is placed in a position where no application icon is placed) or a preset display position of the small floating window on the main interface (when the main interface is full of application icons, the small floating window is displayed in a preset default position).

The in-application switch instruction is used for zooming out the current play interface to display an interface prior to the play, so that the user can browse other contents that he/she is interested in. The display apparatus further includes a swipe direction determining module 307. The in-application switch instruction includes a click switch instruction and a swipe gesture switch instruction;

If the instruction receiving module 301 receives a swipe gesture switch instruction, the swipe direction determining module 307 then determines a swipe direction of the swipe gesture switch instruction.

According to the swipe direction, the display module 303 displays the small floating window in an interface corner pointed by the swipe direction.

In some exemplary embodiments, the swipe direction is upper left, lower left, upper right and lower right directions respectively, so as to be distinguished from other operational gestures.

The play interface is operated by using a swipe gesture, thus simplifying the user's operations, being distinguished from the inter-application switch instruction, improving the user's operation efficiency, and enhancing user experience.

In some exemplary embodiments, the display apparatus further includes a second instruction determining module 308 and a small floating window control module 309;

The instruction receiving module 301 receives a small floating window control instruction.

The second instruction determining module 308 is configured to determine the type of the small floating window control instruction.

If the small floating window control instruction is a zoom control instruction, the small floating window control module 309 is configured to zoom the small floating window.

If the small floating window control instruction is a drag control instruction, the small floating window control module 309 is configured to move the small floating window.

If the small floating window control instruction is a close control instruction, the small floating window control module 309 is configured to close the small floating window.

If the small floating window control instruction is a restore control instruction, the display module 303 is configured to return to the play interface of the target video and continue to play the target video.

The above various types of control instructions all can be achieved by clicking buttons set around the small floating window, or achieved by clicking the small floating window and performing a corresponding gesture operation. For example, the zoom control instruction achieves zooming by pressing a zoom button on a corner of the small floating window and then dragging the small floating window. The drag control instruction achieves dragging and displacement by pressing and dragging the small floating window. The close control instruction is achieved by clicking a close button on a corner of the small floating window, and the restore control instruction may be achieved by clicking a restore button on a corner of the small floating window or by double-clicking the small floating window.

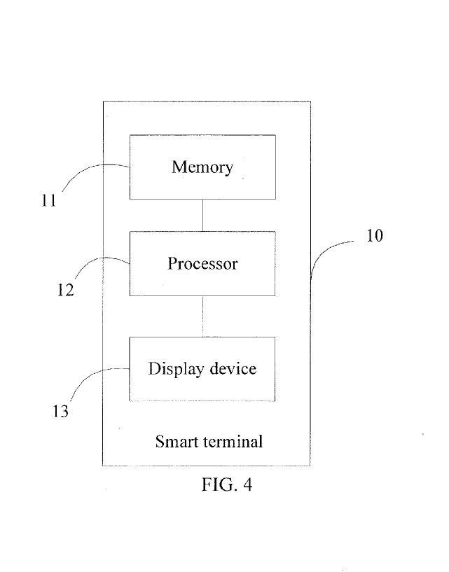

FIG. 4 is a hardware structure diagram of an embodiment of a smart terminal according to the present disclosure.

As illustrated in FIG. 4, the smart terminal 10 includes: a memory 11, at least one processor 12, and a display device 13.

The memory 11 is configured to store executable programs;

The at least one processor 12 is caused to execute the executable programs stored in the memory 11, so as to receive an interface switch instruction under a play interface of a target video, execute an interface switch operation according to the interface switch instruction, display the switched interface and displaying a small floating window in the switched interface, and continue to play the target video in the small floating window.

The display device 13 is configured to display a graphic user interface.

The memory 11 of the smart terminal 10 can be a non-transitory computer-readable memory medium, useful for storing a computer-executable instruction. When the instruction is processed by one or more central processing units, for example, it can make the central processing units to execute steps 101-104 of FIG. 1 or steps 201-216 of FIG. 2 or the functions of units 301-309 of FIG. 3.

The computer-executable instruction can also be stored and/or transmitted in any non-transitory computer-readable memory medium so that it can be used by an instruction executing system, device or apparatus, or be used in combination with an instruction executing system, device or apparatus, wherein the instruction executing system, device or apparatus includes a computer-based system, a processor-containing system, and other systems that can obtain an instruction from another instruction executing system, device or apparatus and execute the instruction. For the purpose of the present document, “non-transitory computer-readable memory medium” can be any medium that physically contains or stores a computer-executable instruction, which can be used by an instruction executing system, device or apparatus, or be used in combination with an instruction executing system, device or apparatus. The non-transitory computer-readable memory medium can include, but is not limited to, magnetic, optical, and/or semi-conductive memory medium. The examples of the memory medium include disk, optical disk based on CD, DVD or blue light technology, and persistent solid state memory (such as flash memory and solid state actuator).

The processor 12 can be a central processing unit (CPU for short). The processor 12 can also be other general processors, a digital signal processor (DSP), an application-specific integrated circuit (ASIC), a field programmable gate array (FPGA) or other programmable logic devices, discrete gate or transistor logic device, discrete hardware component, etc. The general processor can be a microprocessor or the processor can be any conventional processor.

Direct or indirect communications connection between the processor and the memory can be realized in any proper manner in the related art to accomplish data transmission, and it includes, but is not limited to, physical bus system connection and other invisible network connection. The bus system can include power bus, control bus, state signal bus, etc.

By performing the method for displaying a video being played of the embodiments of the present disclosure, the smart terminal 10 can form a small floating window in the new interface and continue to play a video in the small floating window when a video play interface is switched to another interface, so that the user can do what he/she wants to do in the new interface without interrupting the user from continuing to watch the video, thus enriching operating functions, and enhancing user experience.

Those ordinary skilled in the art should realize: the units and algorithm steps in each example described in the embodiments disclosed in the present application can be performed by electronic hardware, computer software or a combination thereof. To clarify the interchangeability of hardware and software, the constitution and steps in each example have been generally described in the above explanations according to functions. Whether these function are executed by hardware or software depends on the specific applications of the technical solution and the design constraint conditions. As for each specific application, those ordinary skilled in the art can achieve the described functions in different methods, but the achievement should not be deemed to go beyond the scope of the present disclosure. The computer software can be stored in the computer-readable memory medium. During execution, the program can include the flow of the embodiments of the above methods. The memory medium can be disk, optical disk, read-only memory, random memory, and so on.

Those ordinary skilled in the art should understand: the discussion on any of the above embodiments is merely exemplary, without intention to imply that the scope of the present disclosure (including the claims) is limited to those embodiments; consistent with the thought of the present disclosure, combinations of the technical features in one or more of the above embodiments are feasible, and many other changes in different aspects of the present disclosure exist; for conciseness, these combinations and changes are not presented in details. Therefore, any omission, modification, equivalent replacement, improvements among others within the spirit and principle of the present disclosure should be contained within the protection scope of the present disclosure.

What is claimed is:

1. A method for displaying a video being played, comprising:
at an electronic device;
receiving an interface switch instruction under a play interface of a target video;
executing an interface switch operation according to the interface switch instruction;
displaying the switched interface and displaying a small floating window in the switched interface; and
continuing to play the target video in the small floating window.

2. The method according to claim 1, wherein the interface switch instruction comprises an inter-application switch instruction, an in-application switch instruction, and a main interface return instruction.

3. The method according to claim 2, wherein after receiving an interface switch instruction, the method further comprising:
determining the type of the interface switch instruction; and
if the interface switch instruction is an inter-application switch instruction, executing an interface switch operation comprises opening a target application interface;
if the interface switch instruction is an in-application switch instruction, executing an interface switch operation comprises returning to an application interface before playing the target video; and
if the interface switch instruction is a main interface return instruction, executing an interface switch operation comprises returning to a system main interface.

4. The method according to claim 3, further comprising:
presetting a default display position of the small floating window, wherein if the interface switch instruction is an inter-application switch instruction, the default display position of the small floating window is set to an area outside a key content display area of a switched application; and
if the interface switch instruction is a main interface return instruction, the default display position of the small floating window is set to a blank area on the main interface or a preset small floating window display position.

5. The method according to claim 3, wherein the in-application switch instruction comprises a click switch instruction and a swipe gesture switch instruction;
wherein if a swipe gesture switch instruction is received, a swipe direction of the swipe gesture switch instruction is determined and the small floating window is displayed in an interface corner pointed by the swipe direction according to the swipe direction.

6. The method according to claim 1, further comprising:
receiving a small floating window control instruction;
determining the type of the small floating window control instruction; and
if the small floating window control instruction is a zoom control instruction, zooming the small floating window;
if the small floating window control instruction is a drag control instruction, moving the small floating window;
if the small floating window control instruction is a close control instruction, closing the small floating window; and
if the small floating window control instruction is a restore control instruction, returning to the play interface of the target video and continuing to play the target video.

7. An electronic device, comprising:
at least one processor; and
a memory communicably connected with the at least one processor for storing instructions executable by the at least one processor, wherein execution of the instructions by the at least one processor causes the at least one processor to:
receive an interface switch instruction under a play interface of a target video;
execute an interface switch operation according to the interface switch instruction;
display the switched interface and displaying a small floating window in the switched interface; and
continue to play the target video in the small floating window.

8. The electronic device according to claim 7, wherein the interface switch instruction comprises an inter-application switch instruction, an in-application switch instruction, and a main interface return instruction.

9. The electronic device according to claim 8, wherein after receiving an interface switch instruction, execution of the instructions by the at least one processor further causes the at least one processor to:
determine the type of the interface switch instruction; and
if the interface switch instruction is an inter-application switch instruction, executing an interface switch operation comprises opening a target application interface;
if the interface switch instruction is an in-application switch instruction, executing an interface switch operation comprises returning to an application interface before playing the target video; and
if the interface switch instruction is a main interface return instruction, executing an interface switch operation comprises returning to a system main interface.

10. The electronic device according to claim 9, wherein execution of the instructions by the at least one processor further causes the at least one processor to:
preset a default display position of the small floating window, wherein if the interface switch instruction is an inter-application switch instruction, the default display position of the small floating window is set to an area outside a key content display area of a switched application; and
if the interface switch instruction is a main interface return instruction, the default display position of the small floating window is set to a blank area on the main interface or a preset small floating window display position.

11. The electronic device according to claim 9, wherein the in-application switch instruction comprises a click switch instruction and a swipe gesture switch instruction;
wherein if a swipe gesture switch instruction is received, a swipe direction of the swipe gesture switch instruction is determined and the small floating window is displayed in an interface corner pointed by the swipe direction according to the swipe direction.

12. The electronic device according to 7, wherein execution of the instructions by the at least one processor further causes the at least one processor to:
receive a small floating window control instruction;
determine the type of the small floating window control instruction; and
if the small floating window control instruction is a zoom control instruction, zoom the small floating window;
if the small floating window control instruction is a drag control instruction, move the small floating window;
if the small floating window control instruction is a close control instruction, close the small floating window; and
if the small floating window control instruction is a restore control instruction, return to the play interface of the target video and continue to play the target video.

13. A non-transitory computer-readable storage medium storing executable instructions, wherein when executed by an electronic device, causes the electronic device to:
receive an interface switch instruction under a play interface of a target video;
execute an interface switch operation according to the interface switch instruction;
display the switched interface and display a small floating window in the switched interface; and
continue to play the target video in the small floating window.

14. The non-transitory computer-readable storage medium according to claim 13, wherein the interface switch instruction comprises an inter-application switch instruction, an in-application switch instruction, and a main interface return instruction.

15. The non-transitory computer-readable storage medium according to claim 14, wherein after receiving an interface switch instruction, the executable instructions are executed by the electronic device, further causes the electronic device to:
determine the type of the interface switch instruction; and
if the interface switch instruction is an inter-application switch instruction, executing an interface switch operation comprises opening a target application interface;
if the interface switch instruction is an in-application switch instruction, executing an interface switch operation comprises returning to an application interface before playing the target video; and
if the interface switch instruction is a main interface return instruction, executing an interface switch operation comprises returning to a system main interface.

16. The non-transitory computer-readable storage medium according to claim 15, wherein the executable instructions are executed by the electronic device, further causes the electronic device to:
preset a default display position of the small floating window, wherein if the interface switch instruction is an inter-application switch instruction, the default display position of the small floating window is set to an area outside a key content display area of a switched application; and
if the interface switch instruction is a main interface return instruction, the default display position of the small floating window is set to a blank area on the main interface or a preset small floating window display position.

17. The non-transitory computer-readable storage medium according to claim 15, wherein the in-application switch instruction comprises a click switch instruction and a swipe gesture switch instruction;
wherein if a swipe gesture switch instruction is received, a swipe direction of the swipe gesture switch instruction is determined and the small floating window is displayed in an interface corner pointed by the swipe direction according to the swipe direction.

18. The non-transitory computer-readable storage medium according to 13, wherein the executable instructions are executed by the electronic device, further causes the electronic device to:
receive a small floating window control instruction;
determine the type of the small floating window control instruction; and
if the small floating window control instruction is a zoom control instruction, zoom the small floating window;
if the small floating window control instruction is a drag control instruction, move the small floating window;
if the small floating window control instruction is a close control instruction, close the small floating window; and
if the small floating window control instruction is a restore control instruction, return to the play interface of the target video and continue to play the target video.
